(19) United States
(12) Patent Application Publication
(10) Pub. No.: US 2009/0103894 A1
(43) Pub. Date: Apr. 23, 2009

(54) DIGITAL BROADCASTING RECORDING APPARATUS AND DIGITAL BROADCASTING RECORDING METHOD

(75) Inventor: Tomochika Yamashita, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, ltd.

(21) Appl. No.: 12/250,754

(22) Filed: Oct. 14, 2008

(30) Foreign Application Priority Data
Oct. 18, 2007 (JP) 2007-271630

(51) Int. Cl. H04N 5/91

(52) U.S. Cl. 386/83

(57) ABSTRACT

When a digital broadcasting program is recorded into a recording medium, a series program such as a series drama is automatically and exactly recorded and stored into a predetermined folder. A digital broadcasting recording apparatus includes a controlling unit which sets a recording schedule of the program and controls a folder for storing the program. An item for selecting a specific folder, as a destination folder of a recording program at the time of setting a recording schedule, with the same name as a program title is provided. In the case where the specific folder is selected, the controlling unit produces the specific folder with the same name as the program title to store the program at the time of recording the scheduled program.

### CLAIM OF PRIORITY

The present application claims priority from Japanese patent application serial no. JP 2007-271630, filed on Oct. 18, 2007, the content of which is hereby incorporated by reference into this application.

### BACKGROUND OF THE INVENTION

(1) Field of the Invention

The present invention relates to a digital broadcasting recording apparatus and a digital broadcasting recording method in which a digital broadcasting program is classified for each folder for recording.

(2) Description of the Related Art

When digital broadcasting programs are recorded into a recording medium such as an HDD, it is convenient if the programs having the relevant contents are recorded and stored into a shared folder. In this case, a user manually produces the folder beforehand, and designates the already-produced folder at the time of registering a recording schedule so as to store the recording program into the folder. Alternatively, when a program with the same title as an already-recorded program is recorded in accordance with a recording schedule, a folder with the same name as the program title is automatically produced (automatic folder production), and thereafter, the program is stored into the produced folder.

Japanese Patent Application Laid-Open No. 2007-80447 discloses an information recording/reproducing apparatus which includes, with the aim of automatically recording and storing video data into a specific folder conforming to recording conditions, a recording condition setting unit which sets recording conditions such as a recording date and time and a broadcasting channel through a user at the time of recording video data, an acquisition unit which acquires folder attribution information that is set in each folder on a disk, and a producing unit which newly produces a folder when there is no folder conforming to the recording conditions set by the recording condition setting unit. It is described that this configuration enables classifying and recording the video data for each folder in accordance with the folder attribution information.

### SUMMARY OF THE INVENTION

In the case where a digital broadcasting program is recorded and reproduced into/from a recording medium such as an HDD, if the number of recorded programs is increased, it is a troublesome task to search for a desired program among the recorded programs for reproducing. As described above, a folder is produced and the same series drama is classified for each folder for recording, so that the desired program can be easily found. However, in the conventional technique, it is necessary for a user to produce the folder in advance, which is inconvenient for the user. In the case of Japanese Patent Application Laid-Open No. 2007-80447, it is a troublesome task for a user to set the recording conditions such as a recording date and time and a broadcasting channel for a folder to be newly produced.

Further, in the above-described automatic production method of a folder, in the case where two or more pieces of program data with the same title are recorded, a folder with the same name as the program title is automatically produced on an HDD. Then, when program data with the same title are thereafter recorded, the data can be automatically stored into the folder. However, even if a program to be newly recorded is a series program such as a series drama, a part of the program title is different from the name of the folder in some cases. As a result, there is a possibility that the program is not stored into the folder where the program is supposed to be stored. In addition, in the case where the program is classified on the basis of the recording conditions such as a recording date and time and a broadcasting channel as described in Japanese Patent Application Laid-Open No. 2007-80447, another program that is broadcasted at the same time slot after the termination of the broadcasting of the series program is continued to be stored, and thus it is necessary for a user to change the recording conditions for the folder.

In view of the foregoing problems in the conventional technique, it is an object of the present invention to automatically and exactly record and store a series program such as a series drama into a predetermined folder.

A digital broadcasting recording apparatus of the present invention in which a digital broadcasting program is classified for each folder and is recorded into a recording medium includes: a recording/reproducing unit which records and reproduces the program into/from the recording medium; a memory into which recording schedule information of the program is stored; and a controlling unit which sets a recording schedule of the program and controls a folder for storing the program. An item for selecting a specific folder, as a destination folder of a recording program at the time of setting a recording schedule, with the same name as a program title is provided, and in the case where the specific folder is selected, the controlling unit produces the specific folder with the same name as the program title to store the program at the time of recording the scheduled program. Further, in the case where a repeat-recording schedule is set at the time of setting a recording schedule, the controlling unit stores the corresponding program into the specific folder at the time of repeatedly recording the program.

In a digital broadcasting recording method of the present invention in which a digital broadcasting program is classified for each folder and is recorded into a recording medium, an item for selecting a specific folder, as a destination folder of a recording program at the time of setting a recording schedule, with the same name as a program title is provided, and in the case where the specific folder is selected, the specific folder with the same name as the program title is produced to store the program at the time of recording the scheduled program. Further, in the case where a repeat-recording schedule is set at the time of setting a recording schedule, the corresponding program is stored into the specific folder at the time of repeatedly recording the program.

According to the present invention, it is possible to automatically and exactly record and store a series program such as a series drama into a predetermined folder, which saves the trouble of a user and improves user-friendliness.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an embodiment of a digital broadcasting recording apparatus according to the present invention;

FIGS. 2A and 2B are diagrams, each showing an example of a recording schedule setting screen in a first embodiment;

FIG. 3 is a diagram showing an example of a recorded program list display screen;

FIG. 4 is a flowchart showing the control of a destination folder in the first embodiment;

FIG. 5 is a flowchart showing the control of a destination folder in a second embodiment; and

FIG. 6 is a flowchart showing the control of a destination folder in a third embodiment.

### DETAILED DESCRIPTION OF THE EMBODIMENT

Hereinafter, embodiments of the present invention will be described using the drawings.

### First Embodiment

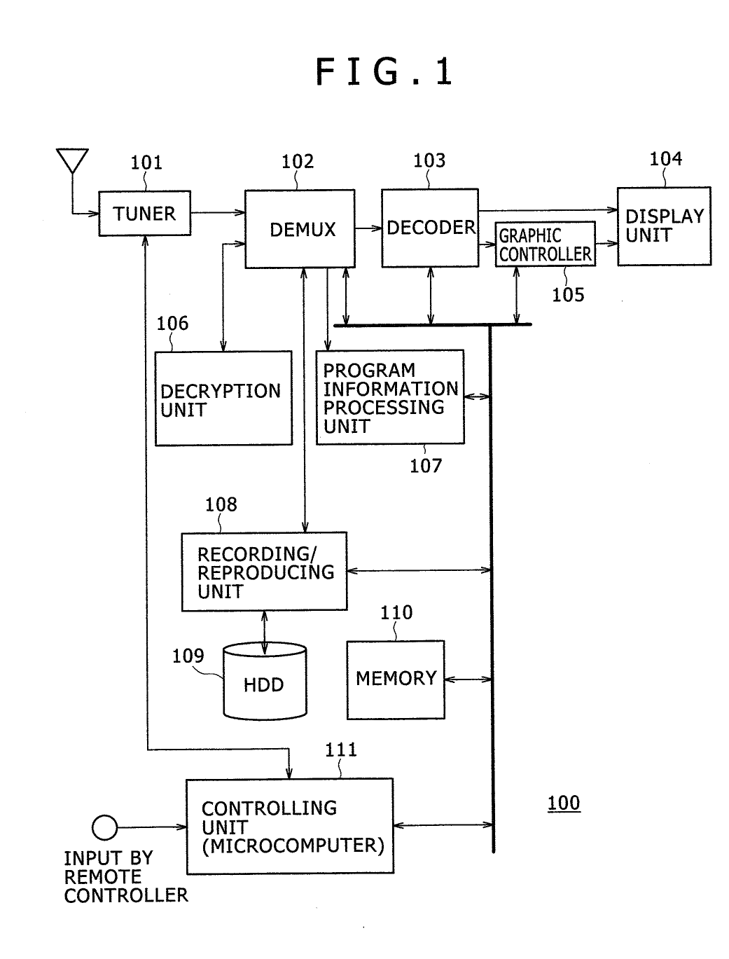

FIG. 1 is a block diagram showing an embodiment of a digital broadcasting recording apparatus according to the present invention. A digital broadcasting recording apparatus 100 of the embodiment is shown so as to be integrated with a television receiver, and has functions of receiving digital broadcasting, recording and reproducing the received program and outputting video and audio to be displayed on a display.

As a configuration of the recording apparatus, the reference numeral 101 denotes a tuner for receiving digital broadcasting to select a desired channel, 102 denotes a demultiplexer for separating the received signal into an audio data stream and a video data stream, 103 denotes a decoder for decoding the coded stream, and 104 denotes a display unit such as a liquid crystal display and a PDP for displaying video and audio. The reference numeral 105 denotes a graphic controller for producing a list of broadcasting programs and an operation screen for a recording schedule and the like to be displayed on the display unit 104. The reference numeral 106 denotes a decryption unit for decrypting a video/audio signal that is transmitted while being encrypted. The reference numeral 107 denotes a program information processing unit for obtaining program information (program title, broadcasting date and time, program contents, and the like) from the received signal to set a recording schedule. The reference numeral 108 denotes a recording/reproducing unit for recording and reproducing a program into/from a recording medium 109 such as an HDD and a DVD. At this time, recording schedule information is stored in a memory 110 and the recording/reproducing unit performs recording in accordance with the stored information. The reference numeral 111 denotes a controlling unit (microcomputer) for controlling the whole apparatus. In particular, the controlling unit sets a recording schedule of a program, and produces and controls a destination folder of the program by operation of a user (input by a remote controller).

In the above-described configuration, the digital broadcasting recording apparatus is integrated with the television receiver. However, these may be separated from each other. Further, the display unit 104 and the recording medium 109 may be connected to the apparatus as external apparatuses.

The digital broadcasting recording apparatus of the embodiment is characterized in that when a desired program is scheduled for recording and registered, a selection item is newly added whereby a folder (hereinafter, referred to as “specific folder”) with the same name as the program title is produced as a destination folder. Specifically, the “specific folder” is newly provided as a selection item of the destination folder on a recording schedule setting screen. In the case where a user selects the item, the “specific folder” is produced for storing at the time of performing the scheduled recording. Further, in the case where the scheduled recording is repeatedly performed on a daily or weekly basis, a series program that is repeatedly broadcasted is automatically stored into the “specific folder”. Hereinafter, this operation will be described in detail.

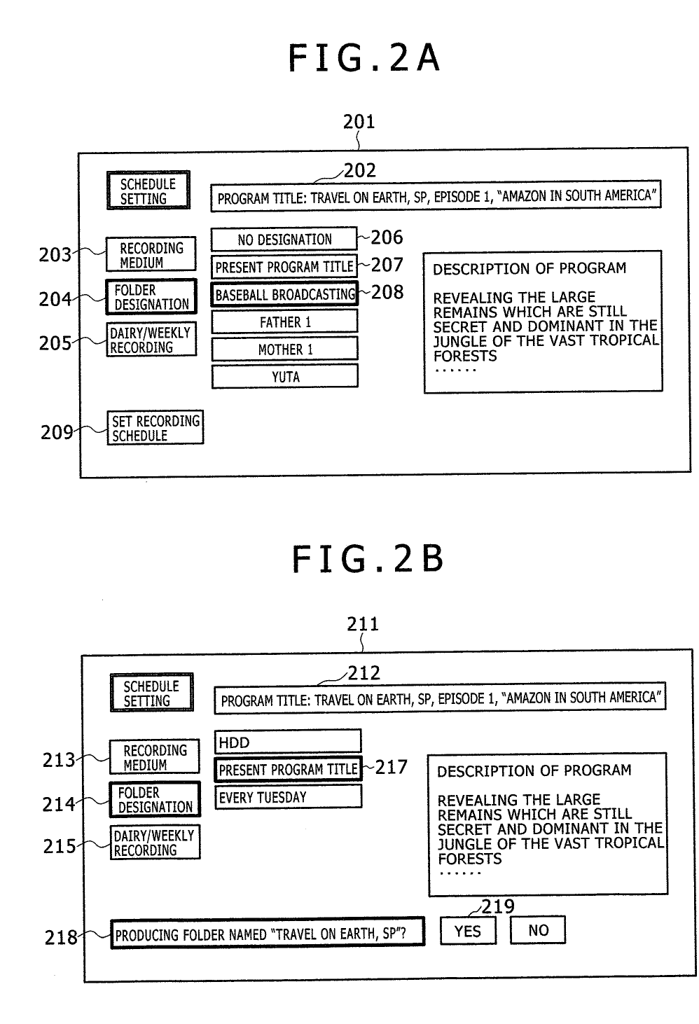

FIGS. 2A and 2B are diagrams, each showing an example of a recording schedule setting screen in the embodiment. FIG. 2A is a folder designation screen and FIG. 2B is a folder confirmation screen on which the specific folder is selected as a destination folder of a recording program.

On a folder designation screen 201 of FIG. 2A, a program title 202 of “travel on earth, SP, episode 1, , , , ” to be recorded is displayed, and a recording medium 203, a folder designation 204, a daily/weekly recording 205, and the like are set as schedule setting items. In this case, the selection items of the folder designation 204 are shown, and a “no designation” 206 is used when a program is not to be stored into a folder (when a program is not classified), a “present program title” 207 is used when a program is to be stored into the specific folder with the same name as the program title, and a “baseball broadcasting” 208 and the subsequent items are used when a program is stored into an already-produced folder. When the “present program title” 207 is selected, the screen is changed to one shown in FIG. 2B.

On a folder confirmation screen 211 of FIG. 2B, setting conditions such as a recording medium 213, a folder designation 214 and a daily/weekly recording 215 are displayed, and it can be understood that a “present program title” 217 is set in the folder designation 214. Here, “producing a folder named “travel on earth, SP”?” is displayed as a confirmation message 218 for folder production. In this case, a user is notified that the specific folder is named as “travel on earth, SP”. The folder name can be easily identified only with top characters of the program title, without using the entire program title. If the user selects a “yes” 219 for acceptance, the specific folder with the name of “travel on earth, SP” is produced. Then, the recording is repeatedly performed on a designated date (every Tuesday in this case) in accordance with the setting conditions of the daily/weekly recording 215, and the program is automatically stored into the specific folder with the name of “travel on earth, SP”.

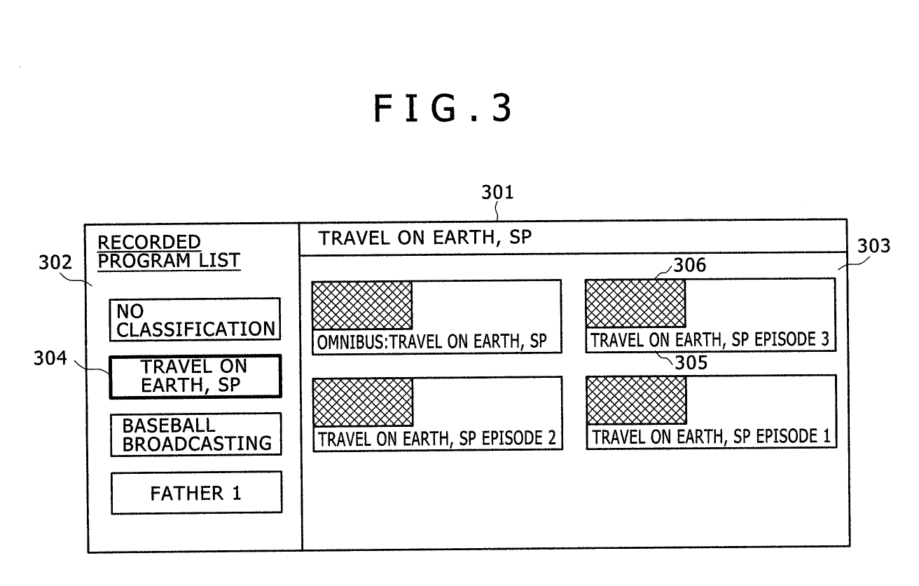

FIG. 3 is a diagram showing an example of a recorded program list display screen. A list display screen 301 includes a folder display area 302 and a recorded program display area 303. The names of produced folders are displayed in the folder display area 302, and when, for example, a “specific folder” 304 with the name of “travel on earth, SP” that is automatically produced in FIGS. 2A and 2B is selected, program contents stored in the specific folder with the name of “travel on earth, SP” are listed and displayed in the recorded program display area 303. In this case, the series program with the title of “travel on earth, SP” is stored in the specific folder with the name of “travel on earth, SP” without lacking any one from episode 1 to the omnibus. In each program, a program title 305 and a thumbnail image 306 that is a representative image of the program are displayed. A user can select a desired program for reproducing and viewing by referring to the thumbnail images.

As described above, when the specific folder (“present program title” 207 in FIG. 2A) with the same name as the program title provided in the embodiment is selected, the specific folder is automatically produced, which saves the trouble of a user. In addition, the program that is repeatedly recorded by setting the daily/weekly recording 215 is automatically stored into the specific folder (“travel on earth, SP” in FIG. 3). Accordingly, even when a part of the title of the series program is changed (for example, “omnibus: travel on earth, SP”), the program can be securely stored into the predetermined folder.

Next, an embodiment of a digital broadcasting recording method of the present invention will be described.

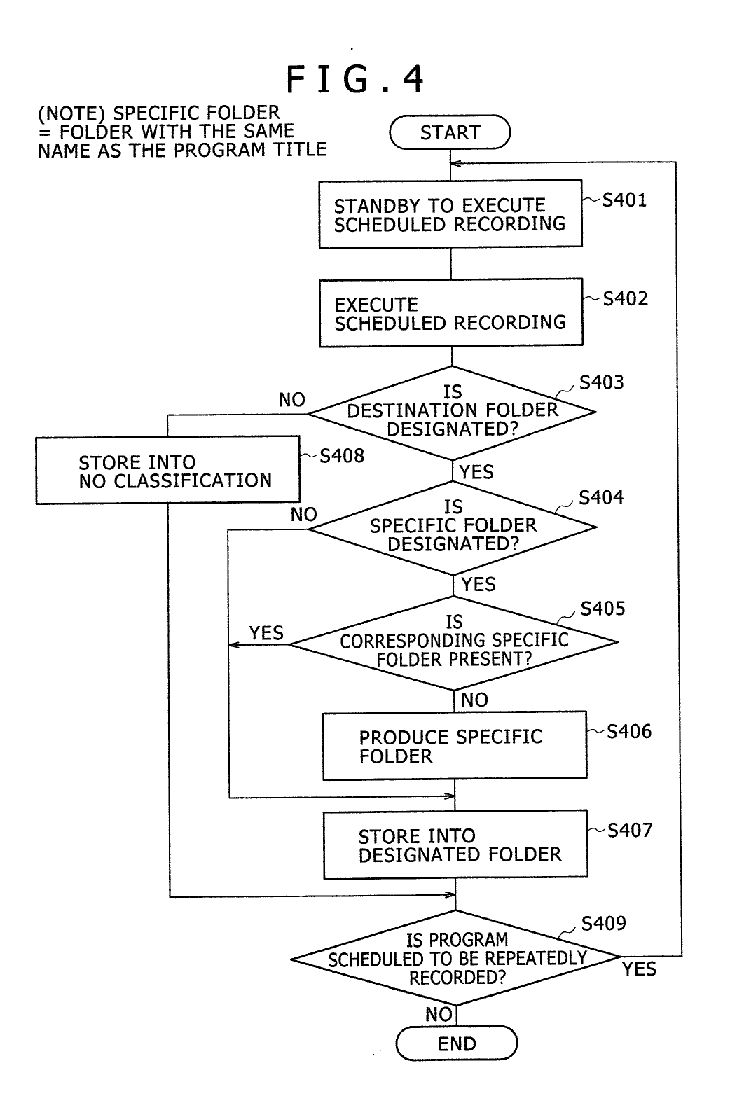

FIG. 4 is a flowchart showing the control of a destination folder in the embodiment. When a user sets items such as the recording medium 203, the folder designation 204, and the daily/weekly recording 205 on the recording schedule setting screen in FIG. 2A, these conditions are stored into the memory 110. The microcomputer 111 performs the recording, produces a folder, and stores the program into the folder in accordance with these conditions. Hereinafter, the control of the microcomputer 111 will be described.

S401 is in a standby state after a recording schedule is set. In S402, the scheduled program is recorded into a designated medium (for example, HDD). In S403, a folder for storing the recorded program is determined. If one of the folders 207 and 208 is set in the folder designation 204, the flow proceeds to S404. When the “no designation” 205 is set in the folder designation 204, the flow proceeds to S408 in which the program is stored as no classification.

In S404, it is determined whether or not the specific folder (“present program title” 207) with the same name as the program title is set in the folder designation 204. In the case of Yes in the determination of S404, it is determined in S405 whether or not the corresponding specific folder is already present. When a series program is recorded for the first time, the corresponding specific folder is not usually present. When the series program is recorded for the next time or later, the corresponding specific folder is present. In the case of No (not present) in the determination of S405, the specific folder is produced in S406. Then, the program is stored into the designated folder (the specific folder in this case) in S407. In the case of Yes (present) in the determination of S405, the program is stored into the already-produced specific folder in S407.

In the case of No in the determination of S404, the program is stored into the specified folder 208 with the name different from the program title in S407.

In S409, it is determined whether or not the program is scheduled to be repeatedly recorded. If the program is scheduled to be repeatedly recorded, the flow returns to S401 to repeat recording for the next program.

By the above-described control, when the specific folder is set by a user in the folder designation, the specific folder with the same name as the program title is produced and the subsequent series program can be automatically stored into the specific folder. At this time, even when the title of the program to be stored is not completely equal to the name of the destination specific folder, the series program can be securely stored.

In the embodiment, there is shown an example of producing the specific folder after the scheduled recording is executed for the first time. However, the specific folder may be produced immediately after the specific folder is selected in the folder designation and the recording schedule is registered.

### Second Embodiment

Next, there will be described an example in which when a recording program is a series program, a specific folder with the same name as the program title is automatically produced, and the repeatedly-recorded program is stored into the specific folder. In this case, the selection item of the “present program title” 207 is not necessary in the folder designation screen described in the first embodiment (FIG. 2A).

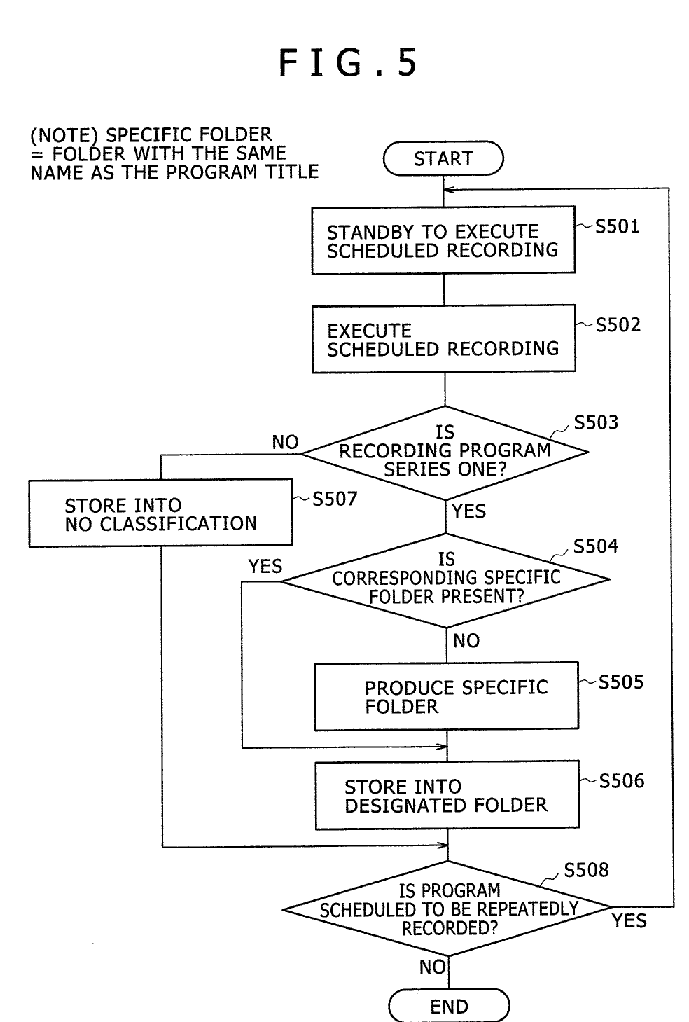

FIG. 5 is a flowchart showing the control of a destination folder in the embodiment.

S501 is in a standby state after a recording schedule is set. In S502, the scheduled program is recorded into a designated medium. In S503, the genre of the recorded program is determined, namely, whether or not the recorded program is a series program (for example, drama and cartoon) is determined. Program information such as EPG (Electronic Program Guide) may be used for determination. In the case of Yes (series program) in the determination of S503, it is determined in S504 whether or not the specific folder with the same name as the program title is already present. In the case of No (not present) in the determination of S504, the specific folder is produced in S505. Then, the program is stored into the produced specific folder in S506. In the case of Yes (present) in the determination of S504, the program is stored into the already-produced specific folder in S506.

In the case of No (other than a series program) in the determination of S503, the flow proceeds to S507 in which the program is stored as no classification.

In S508, it is determined whether or not the program is scheduled to be repeatedly recorded. If the program is scheduled to be repeatedly recorded, the flow returns to S501 to repeat recording for the next program.

By the above-described control, when a recording program is a series program, the specific folder with the same name as the program title is automatically produced, and the subsequent series program can be automatically stored into the specific folder. Accordingly, the embodiment is further effective in saving the trouble of a user.

### Third Embodiment

There is a possibility that the repeatedly-recorded program is different from the series program in the first embodiment. For example, despite the termination of broadcasting of the series program, if the recording schedule is continued to be set in the same time slot, another program replacing the series program is stored. In the embodiment, there is provided a step of confirming whether or not the title of a program to be stored is equal to the name of the specific folder, and when at least a part thereof is not equal to each other, the program is controlled not to be stored into the folder.

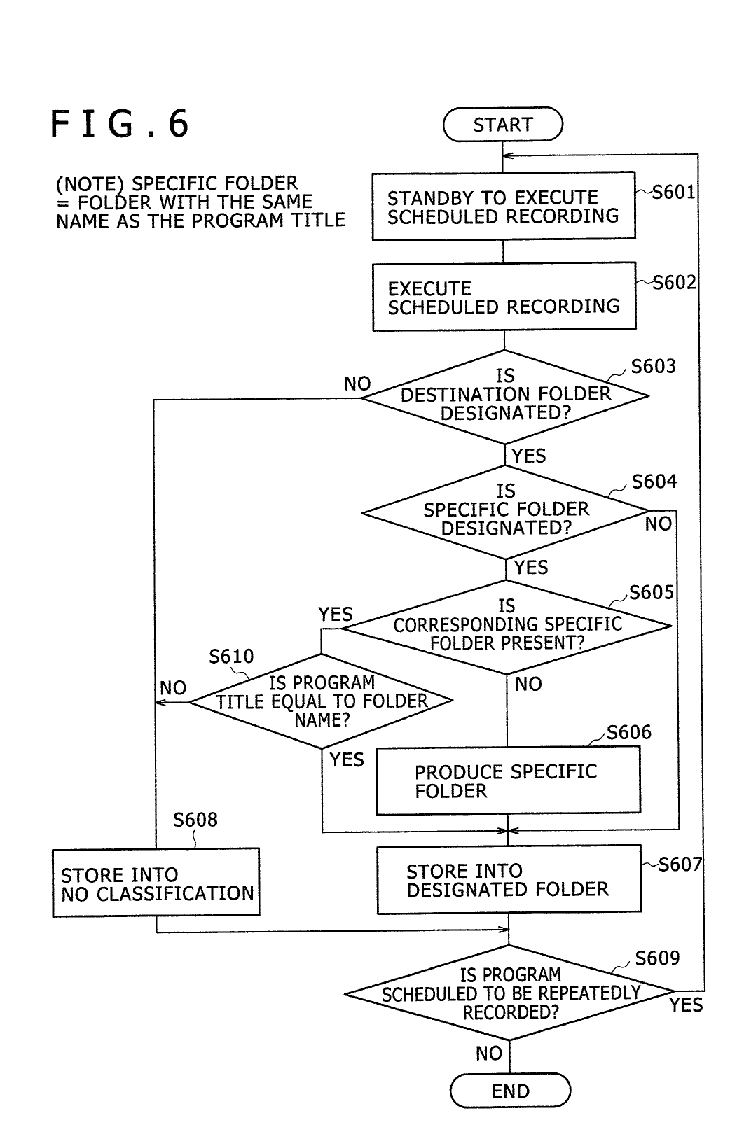

FIG. 6 is a flowchart showing the control of a destination folder in the embodiment. The steps of S601 to S609 correspond to those of S401 to S409, respectively, in the first embodiment (FIG. 4), and thus the explanation thereof will not be repeated.

In the embodiment, if it is determined in S605 that the corresponding specific folder is already present (Yes in S605), the flow further proceeds to S610 in which it is determined whether or not the title of the program is equal to the name of the specific folder. In this case, if all or a part thereof is equal to each other, it is determined as “equal”, and the program is stored into the designated folder (the specific folder in this case) in S607. If it is determined as “not equal” in S610, the flow proceeds to S608 in which the program is stored as no classification.

According to the embodiment, it is confirmed whether or not the title of the program to be stored is equal to the name of the specific folder, and then, if they are not equal to each other, the program is not stored into the specific folder. Accordingly, another program is not stored, by mistake, into an exclusive folder for a series program.

The above-described embodiments are applied to the case in which digital broadcasting is received to record and store a desired program. However, according to the present invention, even in the case of services where desired video/audio contents are downloaded via a network, a folder with the same name as the title of the contents is produced, and thus, series contents can be automatically stored into the same folder.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A digital broadcasting recording apparatus in which a digital broadcasting program is classified for each folder and is recorded into a recording medium, the apparatus comprising:
a recording/reproducing unit which records and reproduces the program into/from the recording medium;
a memory into which recording schedule information of the program is stored; and
a controlling unit which sets a recording schedule of the program and controls a folder for storing the program,
wherein an item for selecting a specific folder, as a destination folder of a recording program at the time of setting a recording schedule, with the same name as a program title is provided, and in the case where the specific folder is selected, the controlling unit produces the specific folder with the same name as the program title to store the program at the time of recording the scheduled program.

2. The digital broadcasting recording apparatus according to claim 1,
wherein in the case where a repeat-recording schedule is set at the time of setting a recording schedule, the controlling unit stores the corresponding program into the specific folder at the time of repeatedly recording the program.

3. A digital broadcasting recording apparatus in which a digital broadcasting program is classified for each folder and is recorded into a recording medium, the apparatus comprising:
a recording/reproducing unit which records and reproduces the program into/from the recording medium; and
a controlling unit which controls a folder for storing the program,
wherein in the case where it is determined on the basis of the genre of the recorded program that the program is a series program, the controlling unit produces a specific folder with the same name as the program title, or stores the program into the specific folder when the specific folder with the same name as the program title is already present.

4. The digital broadcasting recording apparatus according to claim 2,
wherein the controlling unit determines whether or not at least a part of the title of the repeatedly-recorded program is equal to the name of the specific folder, and when it is determined that they are not equal to each other, the program is not recorded into the specific folder.

5. A digital broadcasting recording method in which a digital broadcasting program is classified for each folder and is recorded into a recording medium,
wherein an item for selecting a specific folder, as a destination folder of a recording program at the time of setting a recording schedule, with the same name as a program title is provided, and
in the case where the specific folder is selected, the specific folder with the same name as the program title is produced to store the program at the time of recording the scheduled program.

6. The digital broadcasting recording method according to claim 5,
wherein in the case where a repeat-recording schedule is set at the time of setting a recording schedule, the corresponding program is stored into the specific folder at the time of repeatedly recording the program.

7. A digital broadcasting recording method in which a digital broadcasting program is classified for each folder and is recorded into a recording medium,
wherein in the case where it is determined on the basis of the genre of the recorded program that the program is a series program, the specific folder with the same name as a program title is produced, or the program is stored into the specific folder when the specific folder with the same name as the program title is already present.

8. The digital broadcasting recording method according to claim 6,
wherein it is determined whether or not at least a part of the title of the repeatedly-recorded program is equal to the name of the specific folder, and
when it is determined that they are not equal to each other, the program is not stored into the specific folder.
